(19) United States
(12) Patent Application Publication
(10) Pub. No.: US 2025/0374340 A1
(43) Pub. Date: Dec. 4, 2025

(54) QOS FLOW CONFIGURATION FOR USER EQUIPMENT TO USER EQUIPMENT COMMUNICATIONS

(71) Applicant: Nokia Technologies Oy, Espoo (FI)

(72) Inventors: Pilar ANDRES MALDONADO, Aalborg (DK); Troels Emil KOLDING, Klarup (DK); Devaki CHANDRAMOULI, Plano, TX (US)

(73) Assignee: Nokia Technologies Oy, Espoo (FI)

(21) Appl. No.: 19/236,047

(22) Filed: Jun. 12, 2025

Related U.S. Application Data
(63) Continuation of application No. 17/790,865, filed on Jul. 5, 2022, now abandoned.
(60) Provisional application No. 62/956,958, filed on Jan. 3, 2020.

(51) Int. Cl. H04W 76/10; H04L 47/283; H04W 28/02

(52) U.S. Cl. CPC H04W 76/10; H04L 47/283; H04W 28/0268

(57) ABSTRACT

In some example embodiment, there may be provided an apparatus configured to at least receive or generate an indication indicative of two flows including a first flow and a second flow, the two flows carrying data from a first user equipment via a cellular network to a second user equipment. Related system, methods, and articles of manufacture are also disclosed.

The present application is a continuation of and claims priority to U.S. application Ser. No. 17/790,865, filed Jul. 5, 2022, which is a US national stage entry of PCT/EP2020/085247, filed Dec. 9, 2020 and claims the benefit of priority to U.S. provisional Application Ser. No. 62/956,958, filed Jan. 3, 2020, all of which are incorporated herein by reference in their entirety.

The subject matter described herein relates to wireless technology.

### BACKGROUND

Time sensitive networks (TSN) may be used to support a variety of applications including applications such as ultra-reliable low-latency communications (URLLC), industrial verticals, and/or the like. In the case of industrial verticals and other mission critical applications, there may be some requirements that are relatively unique, such as certain requirements for low latency, deterministic data transmission, and high reliability, when compared to other 5G cellular services.

### SUMMARY

In some example embodiment, there may be provided an apparatus configured to at least receive or generate an indication indicative of two flows including a first flow and a second flow, the two flows carrying data from a first user equipment via a cellular network to a second user equipment.

In some variations, one or more of the features disclosed herein including the following features can optionally be included in any feasible combination. The indication may be generated based on a request from the first user equipment, the second user equipment, and/or an application function. The apparatus may be further caused to at least link, based at least on the indication, the first flow to the second flow to enable modification of the two flows. The first flow may include a first protocol data unit session of the first user equipment, and the second flow may include a second protocol data unit session of the second user equipment. The apparatus may be further caused to at least derive at least one of a quality of service parameter a policy that considers both the first flow and the second flow, the derivation based on at least the connectivity conditions of both the first user equipment and the second user equipment. The indication may be received from a policy control function. The indication may be included in a policy control message. The apparatus may be further caused to at least send the indication towards another node so that the first flow and the second flow can be established, modified, released, and/or created based on at least the connectivity conditions of both the first user equipment and the second user equipment. The indication may include a dependent flow identifier indicating the first flow and the second flow are linked. The indication may include an address of the second user equipment. The first flow and the second flow may carry time sensitive communications between the first user equipment and the second user equipment via at least one network node.

The above-noted aspects and features may be implemented in systems, apparatus, methods, and/or articles depending on the desired configuration. The details of one or more variations of the subject matter described herein are set forth in the accompanying drawings and the description below. Features and advantages of the subject matter described herein will be apparent from the description and drawings, and from the claims.

### DESCRIPTION OF DRAWINGS

In the drawings,

FIGS. 1A and 1B depict an example of UE to UE communications, in accordance with some example embodiments;

FIG. 2A depicts an example of a portion of a time sensitive network, in accordance with some example embodiments;

FIG. 2B depicts an example of a 3GPP bridge for a time sensitive network, in accordance with some example embodiments;

FIGS. 3A-1, 3A-2, and 3A-3 depict an example of a signaling diagram including the use of a dependent flow identifier to link two flows for the two UEs in UE to UE communications, in accordance with some example embodiments;

FIGS. 3B-1, 3B-2, 3B-3, 3B-4, 3B-5, and 3B-6 depict another example of a process flow for UE-UE communications, in accordance with some example embodiments;

FIG. 4 depicts an example of a network node, in accordance with some example embodiments; and

FIG. 5 depicts an example of an apparatus, in accordance with some example embodiments.

Like labels are used to refer to same or similar items in the drawings.

### DETAILED DESCRIPTION

Some Time Sensitive Communications (TSC) use cases may involve communications between machines, such as between user equipment (UE) located in the 5G network. In 3GPP TS 22.104, a few application areas, such as within factories and the like, may be optimized for UE to UE (UE-UE) communications to provide improved service, end-to-end latency, maintainability, and flexibility. For example, control communications between UEs may be provide optimized TSC communications between individual components (or functions) of a larger machine (e.g., the components of the larger machine may operate via UE-UE communications in a TSC manner). Similarly, the UE-UE communications may be used to coordinate individual machines (which include UEs) when performing a task. These machines (which include UEs) may be synchronized and exchange real-time (or near real-time) information. Moreover, these machines may not have a fixed configuration (e.g., as control nodes their configuration may vary as the status of the corresponding machine changes). The UE-UE communications disclosed herein refers to communications, such as TSC communications or other traffic types having demands for low latency and high reliability, via the cellular network, rather than device-to-device (D2D) communications directly between the UEs.

Although the previous example refers to TSC communications within a factory, TSC may be used in other environments, such as in the audio industry, the video industry, and the like. Within these use case examples, the flows, such as the deterministic flows found in TSC, may transmit audio and/or video to a limited geographic area (e.g., a live concert) and/or wider areas (e.g., a concert broadcasting).

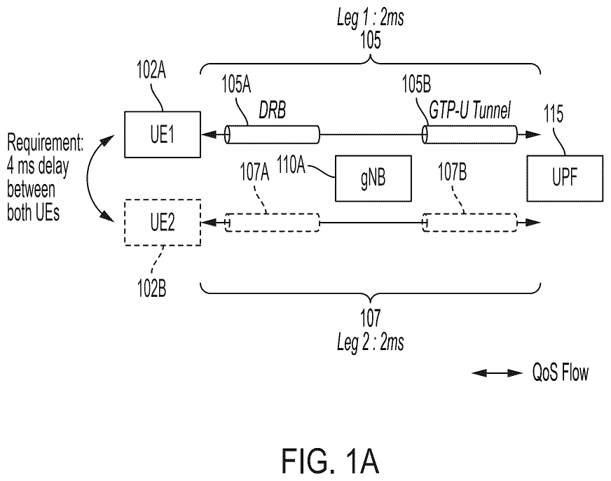

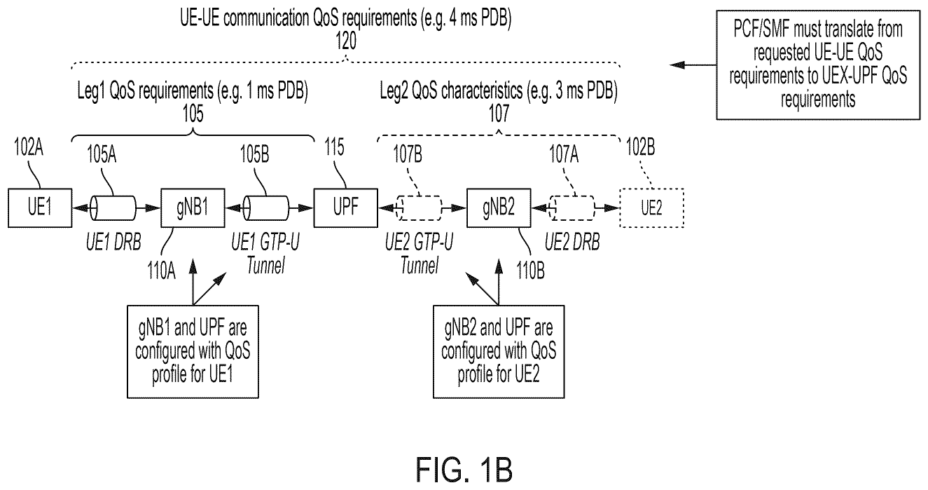

Although two UEs may be connected to the same cellular network and may camp in the same geographical area, the radio conditions at each of the UEs may differ significantly. And, these conditions at each UE may be dynamic in the sense that the conditions may change from time to time. For example, the UEs may be mobile or may encounter different obstructions and the like (e.g., different structures such as walls or obstacles within a factory may cause radio or RF obstructions). As such, the radio conditions for the two UEs may be not be the same, such as asymmetric. When establishing a data communication link between these two UEs in a cellular network such as 5G as shown at FIG. 1A, the cellular network may consider the quality of service (QoS) requirements, and may then establish two independent, new QoS flows between each of the UEs 102A-B and a corresponding user plane function (UPF) 115 via a base station such as a 5G gNB type base station 110A. Although FIG. 1A depicts the UE-UE communications link including the first leg 105 and the second leg 107 via a single base station 110A, the UE-UE communications link may be via two base stations as well as shown in the example of FIG. 1B.

In the example of FIG. 1A, the UE-UE communications link includes a first leg 105 including communication links 105A-B and a second leg 107 including communication links 107A-B. For example, the first leg 105 may include a radio link 105A (which may include an uplink and/or a downlink via data radio bearer(s), DRBs) from the UE 102A and gNB 110A and a GTP-U tunnel 105B (GPRS tunneling protocol-user plane tunnel(s)) between the gNB 110A and user plane function (UPF) 115. And, the second leg 107 may include a radio link 107A (which may include an uplink and/or a downlink via data radio bearer(s), DRBs) from the UE 102B and gNB 110A and a GTP-U tunnel 107B between the gNB 110A and UPF 115.

If the end-to-end latency requirement is 4 milliseconds for example, the cellular network may configure both QoS flows (for both legs 105 and 107) to satisfy a maximum delay of 2 milliseconds (ms) for each leg 105 and 107 as there is no current mechanism in the cellular network to jointly consider the radio conditions of both UEs 102A-B to support the maximum delay requirement. As such, if the radio condition at UE 102A changes drastically, the cellular network needs a way to link these two legs for UE-UE communications, so that if the radio conditions change at, for example, UE 102A and first leg 105, the network can jointly consider the change and perhaps make adjustments to UE 102B and the second leg 107.

To illustrate further, if the radio conditions at UE 102A change for the worse so that latency on the first leg increases to 3 milliseconds, the cellular network may, in accordance with some example embodiments, modify the session for UE 102B so that the latency is 1 millisecond. In some example embodiments, there is provided a Dependent Flow Identifier (ID) that indicates that the two UEs (or their corresponding sessions, flows, or QoS flows) are linked to (e.g., depend on, associated with, mapped to, and/or the like) one another as part of an end-to-end UE-UE communications link. Thus in the example of FIG. 1A, the UE-UE communications link represents a first flow, such as a QoS flow, of packets over the first leg 105 and a second flow, such as a QoS flow over the second leg 107. These two flows are linked by a Dependent Flow ID, in accordance with some example embodiments to enable nodes, such as network functions (NFs), to detect that these flows should be considered together with respect to QoS, assigning radio and other resources, and the like. For TSC services using UE-UE communications with latency or other QoS related requirements, the joint consideration of the actual, current conditions (which do change from time to time) of both UEs 102A-B may provide more flexibility to the cellular network to customize the QoS profiles configuration for the UEs.

In 5G, a QoS flow represents a flow of traffic associated with a session, such as a protocol data unit (PDU) session. The PDU session is a session or a logical connection between the UE and a data network (DN). The QoS flow may be associated with (e.g., mapped to) one or more QoS requirements that are specified by QoS parameters and/or QoS characteristics. For example, the QoS profile of a QoS flow may include one or more QoS parameters, such as a 5G QoS identifier, an allocation and retention priority, a guaranteed flow bit rate, a maximum flow bit rate, a maximum packet loss rate for both uplink and downlink, a reflective QoS attribute, and the like. The QoS characteristics may include one or more of the following: a resource type (e.g., guaranteed bit rate (GBR), a delay critical GBR, or non-GBR), a priority level, a packet delay budget, a packet error rate, an averaging window, a maximum data burst volume, and the like. In the 5G QoS model, there is currently no way to consider jointly the connectivity conditions of more than one UE together when configuring a flow, such as a QoS flow, for UE-UE communications.

In some example embodiments, there may be provided a Dependent Flow ID to jointly consider, for UE-UE communications, the connectivity conditions of the UEs, when establishing a UE-UE communications link. The connectivity conditions refer to radio conditions (e.g., at the UE and/or at the base station), radio resource availability at the base station(s) (e.g., availability of radio bearer(s)), availability of user plane network transport (e.g., from the gNB(s) to the UPF), and/or the like which may affect the QoS profile of the flow(s) between the UEs. When managing the UE-UE communications link, the solution disclosed herein may operate over the current 5G QoS model framework but may extend (e.g., add) functionalities to the radio access network (e.g., base station) and/or other nodes (e.g., core network nodes, UEs, and/or the like) to enable optimization of the UE-UE communications link (e.g., path, connection, and/or the like) by taking into account at least (1) the dynamically changing connectivity conditions (e.g., radio conditions and the like) and (2) use of one or more PDU sessions for each UE.

To illustrate further, the protocol data unit (PDU) session and corresponding QoS flow(s) may be initially be established for each UE. When the cellular network becomes aware (e.g., based on a request from an application or a request from the UE(s)) that a QoS flow is targeted for UE-UE communications via the cellular network (e.g., via the UPF or other network node), the cellular network may configure (e.g., set up) policies, such as QoS policies (e.g., a QoS profile and QoS parameters) for the QoS flow(s) for the two UEs. The QoS flows may be set up in such a way that the path for UE-UE communications link may be considered optimal given the needs of the application associated with the UEs, the location of the UEs, the connectivity conditions, radio conditions of the UEs, the radio resources available for individual QoS flows in the corresponding radio access nodes of the UEs (e.g., gNB and the like), etc.

For an end-to-end delay QoS requirement of 4 ms between UE 102A-B for example, the UE 102A to UPF 115 path (leg 105 over 105A-B) may be optimized (by the cellular network) so that it takes 1 ms of delay based on the radio conditions and radio resources, while the UE 102B to UPF 115 path (leg 107 over 107A-B) may be optimized (by the cellular network) so that it takes only 3 ms. Moreover, the Dependent Flow ID may be used to indicate to nodes in the network that the two UEs 102A-B are in a UE-UE communications link, so their QoS flows are dependent on each other given. Based on the QoS policies determined and computed for each QoS flow and corresponding UE (as well as the Dependent Flow ID) for example, the cellular network may then initiate a session modification, such as a PDU session modification procedure(s), to update the QoS policies in the radio access network and the UE(s).

In some example embodiments, there may be provided a novel Non-Access Stratum (NAS) Information Element (IE) referred to herein as a “Linked UE address.” This “Linked UE address” IE may be included in signaling messages between the UE and the network including core network nodes to indicate to the network nodes (e.g., a base station (gNB), a UE, a session management function (SMF), and the like) that the UEs, such as UE 102A-B, are associated with a UE-UE communications link, so their QoS requirements should be linked and, as such, considered jointly. For example, a source UE, such as UE 102A, may include an indication (e.g., the Linked UE address) of the destination UE, such as UE 102B, that the source UE wants to establish a UE-UE communications link. In this way, the UE can indicate to the network the establishment of the UE-UE communications link. In some example embodiments, the information clement, may be included the indication of the destination UE (e.g., Linked UE address) as a NAS IE. When the SMF receives this NAS IE, the SMF can directly read the indication (e.g., the Linked UE address) and detect the source UE's request for a specific flow type, such as the UE-UE communications link. In some example embodiments, this NAS IE may be signaled from a UE to the core network (e.g., a core network node such as the SMF) before a QoS profile is set (and then the QoS rules with source and destination UE addresses in the packet filters). Alternatively, or additionally, the indication of the destination UE (e.g., Linked UE address) may be signaled via a NAS IE from each of the UEs (e.g., UE 102A and 102B) to the core network. For example, UE 102A may include the NAS IE with the indication of the destination UE (e.g., Linked UE address for UE 102B), while UE 102B may include the NAS IE with the indication of the destination UE (e.g., Linked UE address for UE 102A).

To illustrate further, the Linked UE address may be included in PDU session procedure messages (e.g., PDU modification request) to include the identity of the destination UE, such as the IP or MAC address of the destination UE. By including the Linked UE address IE in the message, network nodes may then know that the requested QoS flow involves two UEs. And, the Linked UE address IE may enable confirmation of the two UEs wanting to establish the same UE-UE communications link. If an application server is requesting the UE-UE communication link for example, the Linked UE address IE may be not needed as the application server may send the two UE addresses directly in its request to the cellular network, such as the core network or other node in the cellular network. However, for UE-triggered UE-UE communication link establishment, each UE may send the destination UE address to recognize the UE-UE communications connectivity requested.

In some example embodiments, there may be provided a QoS parameters change that takes into account the entire UE-UE communications link path as well as each leg of the path. For example, there may be two levels of QoS requirements when considering UE-UE communications link 120 as shown at FIG. 1B. The QoS requirements may include a first level over one leg, such as leg one 105 between UE 102A and UPF 115 via gNB 110A and/or leg 2 107 between UE 102B and UPF 115 via gNB 110B. And, the QoS requirements may include a second level over the entire UE to UE path 120, such as between UE 102A and UE 102B. When requesting the establishment of a QoS flows for UE-UE communications link 120, instead of referring to a only single leg (e.g., a single UE-UPF path), the requested QoS parameters (for the UE-UE QoS flows over link 120) may describe, or indicate, the whole path 120 between the UE 102A-B, for example. Within the network configuration however, the core network (or a node therein) may be enabled to map (e.g., allocate a portion) the requested QoS parameters for the entire UE to UE path 120 to a single leg QoS parameter format.

In some example embodiments, network nodes, such as the policy control function (PCF) and the session management function (SMF), may be configured to detect and consider QoS policies for two UEs when establishing (or modifying, releasing, or the like) QoS flows for the UE-UE communications carried via the cellular network.

In some example embodiments, there may be provided a new ID (hereinafter referred to as Dependent Flow ID) to explicitly identify QoS flows linked as being for the UE-UE communications. For example, a network node such as the SMF may allocate the Dependent Flow ID, and this Dependent Flow ID can be unique within the 5G network. This Dependent Flow ID may be forwarded to other network nodes, such as the gNB, Access and Mobility Management Function (AMF), UPF, and policy control function (PCF).

Within each network node, the Dependent Flow ID may map to different elements, as summarized in Table 1 below. At the PCF or the AMF) for example, a Dependent Flow ID may map to 2 PDU session IDs to indicate that these two PDU sessions are for a UE-UE communications link (e.g., link 120 at FIG. 1B), so they should be linked (e.g., considered jointly) with respect to QoS and the like. Likewise, at the UPF, the Dependent Flow ID may map to 1 or 2 PDU session ID(s), 1 or 2 QFI(s), 1 or 2 N4 Session ID(s) (if different or the same UPF serves both UEs 102A-B), and/or N19 tunnel information (if more than one UPF is used to serve UEs 102A-B, for example). For example, the intermediate UPFs (I-UPFs) may be between the gNB serving a first UE 102A while another UPF provides a session anchor for UE 102A and UE 102B (e.g., UE 102A, gNB 110A, the I-UPF, UPF 115, gNB 102B, UE 102B). In this example, the I-UPF may work with one PDU session (the session from UE 102A), so the Dependent Flow ID may map to 1 or 2 IDs or elements depending of the specific NF and the UEs that this NF serves. And at the SMF, the SMF may map the Dependent Flow ID to 2 PDU Sessions Ids, 2 QFIs, and/or 2 N4 Session Ids. Furthermore, the radio access network, such as a gNB type base station 110A or 110B, may map the Dependent Flow ID to 1 or 2 PDU Session ID(s), 1 or 2 QFI(s), 1 or 2 CN tunnel TEID(s), 1 DRB (if the same gNB serves both UEs 102A-B), and/or 2 DRB(s) (if different gNBs serve both UEs 102A-B). To illustrate further, a single gNB may serve both UEs (e.g., UE 102A, gNB 110A, UPF 115, gNB 110A, and UE 102A), in which case the Dependent Flow ID may map to two PDU sessions. Alternatively, or additionally, two gNBs may server the UEs (e.g., UE 102A, gNB 110A, UPF 115, gNB 110B, and UE 102B), in which case the Dependent Flow ID may map to one or two PDU Sessions depending on how the context of both UEs are distributed to both gNBs.

TABLE 1
Dependent Flow ID mapping to other elements within 5GS
Dependent Flow ID maps to:

| RAN | AMF | SMF | UPF | PCF |
|---|---|---|---|---|
| 1 or 2 PDU | 2 PDU Session IDs | 2 PDU Sessions | 1 or 2 PDU | 2 PDU Session IDs |
| Session ID(s), 1 or | | IDs, 2 QFIs, 2 N4 | Session ID(s), 1 or | |
| 2 QFI(s), 1 or 2 | | Session IDs | 2 QFI(s), 1 or 2 N4 | |
| CN tunnel | | | Session ID(s) | |
| TEID(s), 1 or 2 | | | (depending if | |
| DRB(s) | | | different or the | |
| (depending if | | | same UPF serves | |
| different gNBs or | | | both UEs). | |
| the same gNB | | | If more than one | |
| serves both UEs) | | | UPF is used, N19 | |
| | | | tunnel information | |

The configuration of the QoS flows for the UE-UE communications link may be based on the PDU session modification procedure(s), such as 3rd Generation Partnership Project (3GPP), Technical Specification (TS) Group Services and System Aspects, Procedures for the 5G System (5GS), Stage 2, (Release 16) including revisions thereto (hereinafter 3GPP TS 23.502). Thus, a modification may be triggered by the UE or the network (e.g., a gNB, session management function (SMF), or other node). Additionally, the two UEs involved in the UE-UE communications may be served by the same nodes, such as the same gNB, UPF, and the like, or by different gNBs, UPFs, and the like.

Before providing additional description regarding the UE-UE communications technology disclosed herein. The following provides a description related to TSC communications, although the UE-UE communications technology disclosed herein may be used in systems, apparatus, and processes not related to TSC as well. Furthermore, although some of the examples refer to 5G, the UE-UE communications technology disclosed herein may be used with other types of systems and networks as well.

In some systems such as industrial networks including industrial internet of things (IIoT) or Industry 4.0 networks, 3GPP wireless technologies may be applied in addition to wired time sensitive networking (TSN) to provide additional flexibility with respect to mobility and to provide scalability with respect to the quantity of sensors, actuators, and/or the like which can be supported. For example, a TSN or other source of deterministic traffic may couple to a user equipment and use the 3GPP wireless network as a bridge to enable the traffic to traverse the 3GPP network to another device or network, such as another TSN network. As used herein, deterministic traffic refers to predictable, such as periodic traffic, an example of which is TSN traffic, which may be in accordance with IEEE 802.1 series standards, for example.

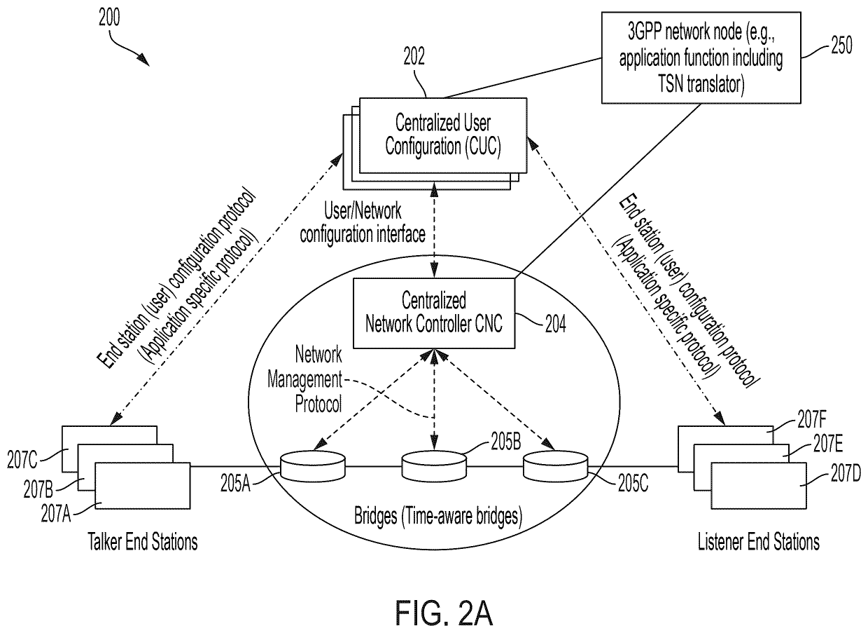

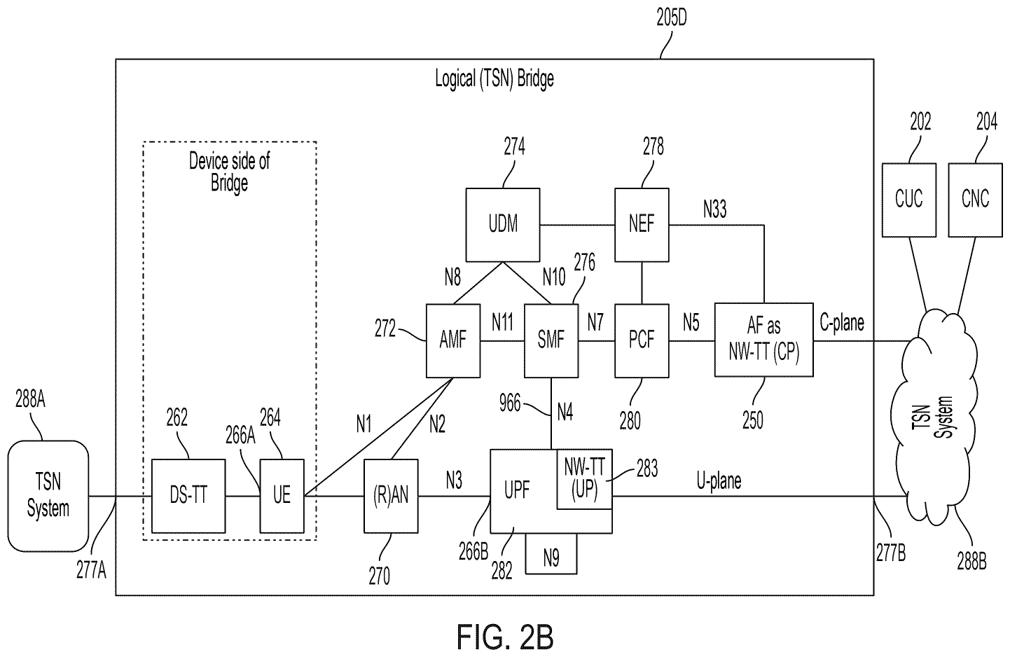

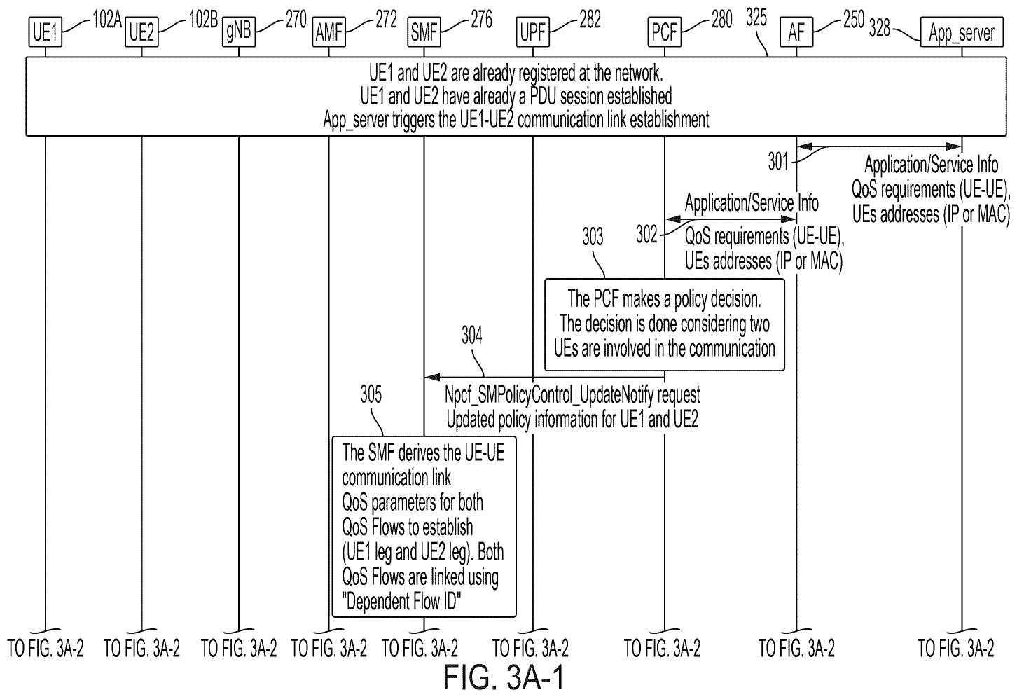

FIG. 2A depicts an example of a TSN network 200 configured in a fully centralized configuration model, although other configuration models may be implemented as well. In the TSN network example of FIG. 2A, the network 200 may include a centralized user configuration (CUC) function 202, a centralized network controller (CNC) 204 function, one or more TSN bridges 205A-C, and one or more end stations 207A-F.

The CUC 202 may be configured in accordance with the one or more of the IEEE 802.1 series of TSN standards. The CUC may control the configuration of end stations 207A-F and/or applications at the end stations. For example, the CUC may interface with the CNC 204 to make requests to the CNC for deterministic, TSN communications (e.g., TSN flows) with specific requirements for those flows between end stations. The TSN flow may represent a time sensitive, deterministic stream of traffic between end stations. These TSN flows may have low delay and/or strict timing requirements for time sensitive networks. For example, a TSN flow (also referred to as a TSN stream) between end stations may, as noted, be used in an industrial control application (e.g., robot, factory machines, etc.) requiring low delay and/or strict, deterministic timing between the end stations. The TSN flow may also have requirements for ultra-low reliability.

The CNC 204 may provide a proxy for the TSN bridges 205A-C and the corresponding interconnections, and provide a proxy for control applications that require deterministic communication. The CNC may define the schedules, such as gate schedules, on which all TSN traffic is transmitted (or received) between the end stations including any intervening devices such as the TSN bridges 205A-C. For example, the schedules may define periodic transmission and/or reception.

The TSN bridges 205A-C may be implemented as Ethernet switches, for example. The TSN bridges are configured to transmit and/or receive TSN flows in accordance with a schedule, such as the gate schedule that gates traffic for transmission or reception. The TSN flow may be in the form of Ethernet frames transmitted and/or received on the schedule to meet the low delay and/or deterministic requirements of the TSN flow. For example, the talker end station 27A may transmit traffic based on the schedule (see, e.g., IEEE 802.1Qbv) to a bridge 105A, which may also receive and/or transmit traffic to another device based on a schedule.

The end stations 207A-F may be a source and/or a destination of a TSN flow. The end stations may include an application, such as an industrial application or other application requiring low delay and/or other time sensitive requirement for a deterministic traffic flow. The end stations may also be referred to as talkers and listeners. Talker end stations refer to an end station that at a given instance is “talking,” such as transmitting in accordance with TSN, while the listener end stations refer to an end station that at a given instance is “listening.” For example, each of the end stations may include circuitry to transmit (e.g., in the case of a “talker”) and/or receive (e.g., in the case of a “listener”) using for example, Time Sensitive Network (TSN) circuitry that enables communications over a TSN network in accordance with the IEEE suite of 802.1 series of standards.

FIG. 2B depicts an example of a TSN bridge 205D, in accordance with some example embodiments. The TSN bridge 205D is also referred to herein as a 3GPP bridge 205D (or 5G system (5GS) bridge) as the 3GPP bridge 205D is implemented as part of the cellular wireless system, such as the 5G system or other type of cellular or wireless system. Referring also to FIGS. 1A-B, each of the UEs 102A and 102B may comprise, or be comprised in, UE 264 to enable the TSC. In the example of FIG. 2B, the TSN system 288A may comprise the end station 207A, which may access the 3GPP bridge 205D via for example a wired connection to a user equipment (UE) 264 and a device side (DS) TSN translator (TT) 262. The user equipment 264 may establish a connection with a user plane function (UPF) 282 (which also includes a network side (NW) TT) via a radio access network (RAN) 270, such as a 5G gNB or other type of base station. The UPF 282 including the NW-TT 282 may provide a TSN compatible user plane data flow to TSN system 288B, which may comprise an end station, such as end station 207D for example.

Moreover, the UE 264 and/or RAN 270 may be configured with a schedule such as a gate schedule (which may be in accordance with IEEE 802.1Qbv). The gate schedule defines when traffic, such as burst, can be transmitted (or received) over the link in order to satisfy the low-latency and/or deterministic needs of TSN. The gate schedule may define the periodicity of the transmission and/or reception of a given device. The links (e.g., uplinks and/or downlinks) via the RAN represent the wireless part of the end-to-end connection between the TSN system 288A and another device or network, such as the TSN system 288B.

The DS-TT 262 and NW-TT 283 may translate TSN user plane data between the TSN system and the 3GPP system (e.g., via an ingress port 266A at the UE and an egress port 266B at the UPF 282. Although FIG. 2B depicts the NW-TT 283 at the UPF 282, the NW-TT may be located at other nodes as well.

One or more nodes of the 3GPP bridge 205D may interface with the CUC 202 and/or CNC 204 to obtain information regarding the end station requirements for the TSN flow connection(s). For example, the AF 250 may interface to the TSN's CUC 202 and/or CNC 204 to obtain information regarding the TSN flows between TSN systems 288A-B (e.g., end stations). The 3GPP bridge 205D may include one or more radio access networks 270 (e.g., a radio access network served by a base station, gNB, eNB, and/or other nodes including core network nodes) to enable wireless connectivity for an end-to-end TSN flow between the TSN systems. Referring again to FIG. 2A, one or more of the bridges 205A-C may be implemented using the 3GPP bridge 205D of FIG. 1B to provide TSN support over the 5G wireless system. From the perspective of the end stations 207A and D for example, the 5G system's 3GPP bridge 205D appears like a more traditional wired TSN bridge.

FIG. 2B also depicts other network elements including an Access and Mobility Management Function (AMF) 272, a User Data Management (UDM) function 274, a Session Management Function (SMF) 276, a Policy Control Function (PCF) 280, a Network Exposure Function (NEF) 278, and an Application Function (AF) 250. In some implementations, the TSN system 288B may include a corresponding UE and/or DS-TT to mirror the UE 264 and DS-TT. Referring also to FIGS. 1A-B, UE 102A may comprise, or be comprised in, UE 264, while UE 102B may be similarly implemented. In the case of UE-UE communications for example where the QoS flows in each of the legs of the user plane are coordinated as being dependent, both UEs may be configured such that they are being served by at least one of RAN 270. In other words, the UEs 102A-B may be configured as described with respect to UE 264.

With respect to the integration of 5G and TSN, the integration may only support a TSN fully centralized model as noted above. In this centralized model, the CUC 202 may be primarily responsible for the end stations' configuration and application requirements management, while the CNC 204 may configure the TSN bridges using a relatively complete view of the physical topology of the network and the capabilities of each TSN bridge. The 5G system may, as noted, provide one or more 3GPP bridges of the TSN network. The granularity of each 3GPP bridge is at a per user plane function (UPF) level. As such, all protocol data unit (PDU) sessions (which connect to the same TSN network via a specific UPF) may be grouped into a single, logical 3GPP bridge, such as 3GPP bridge 205D.

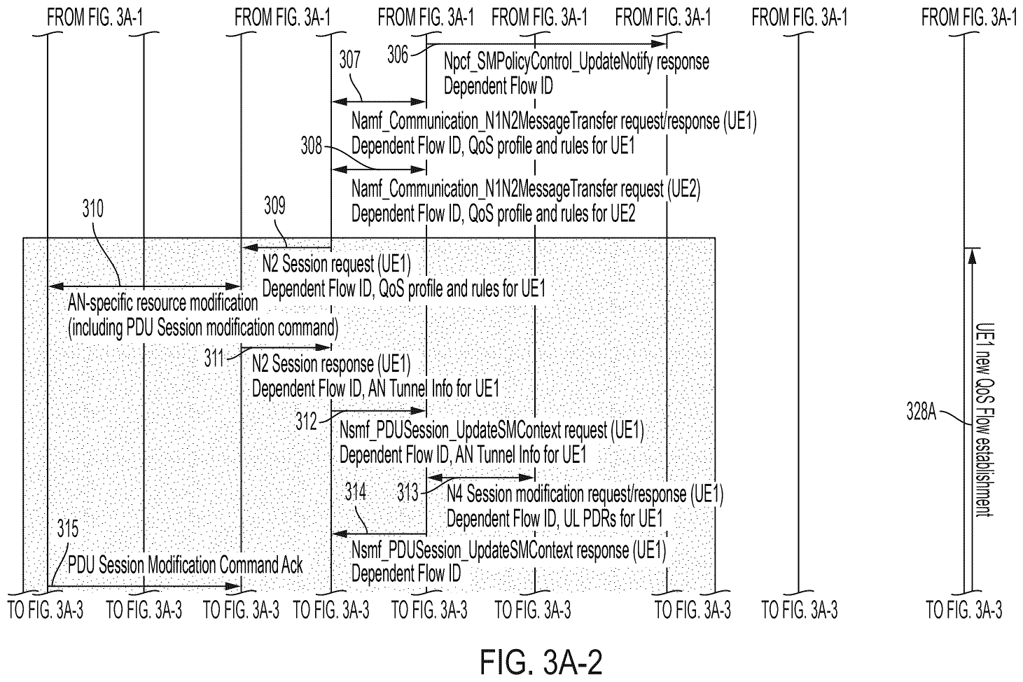

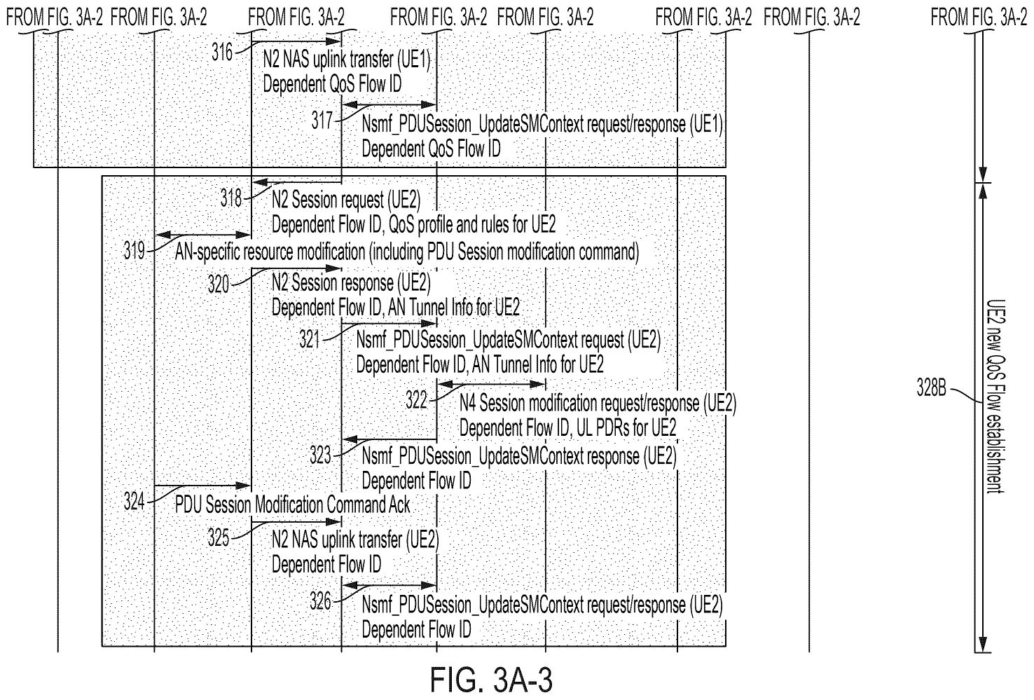

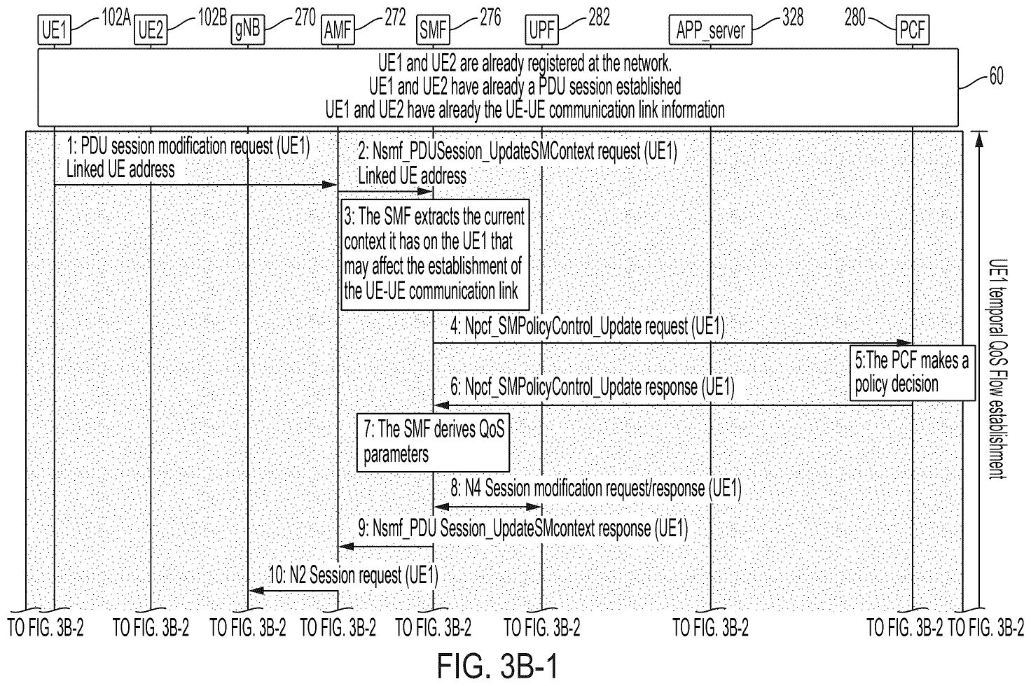

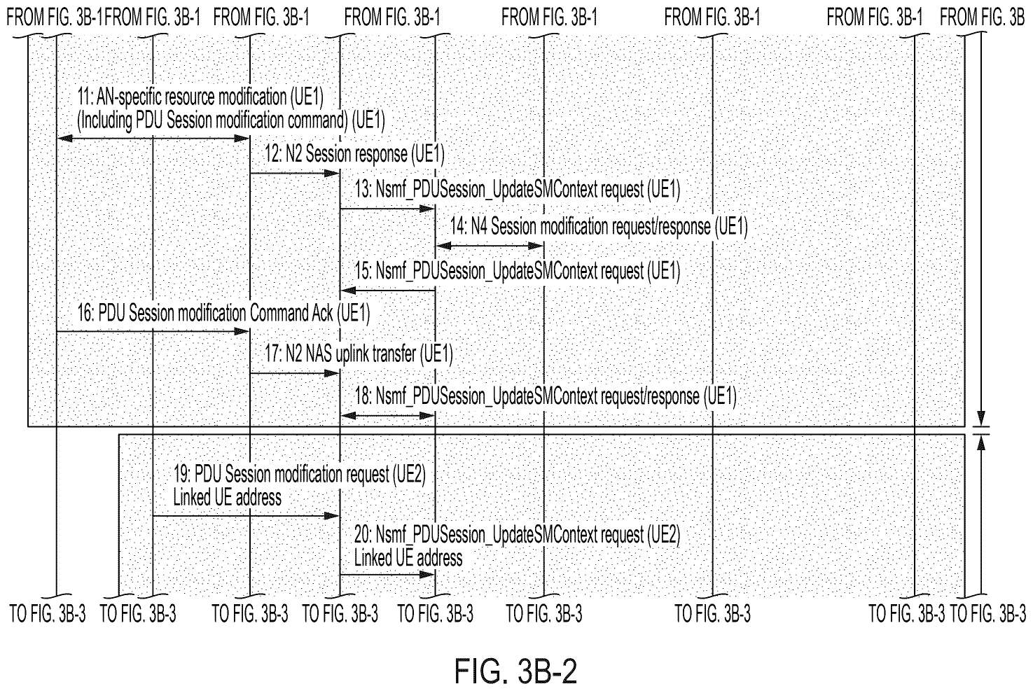

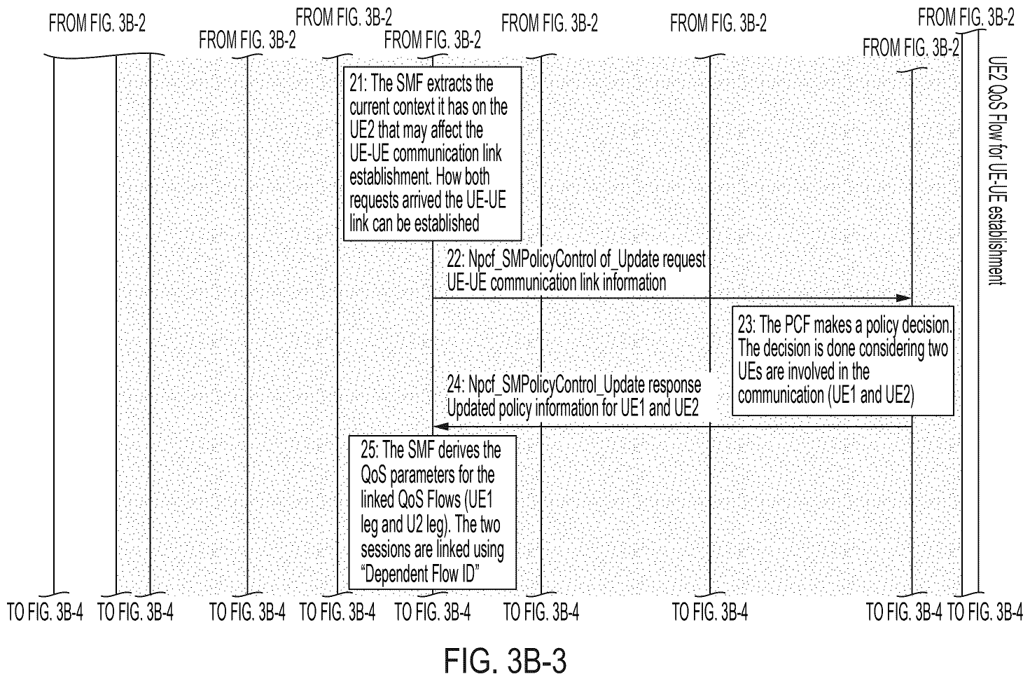

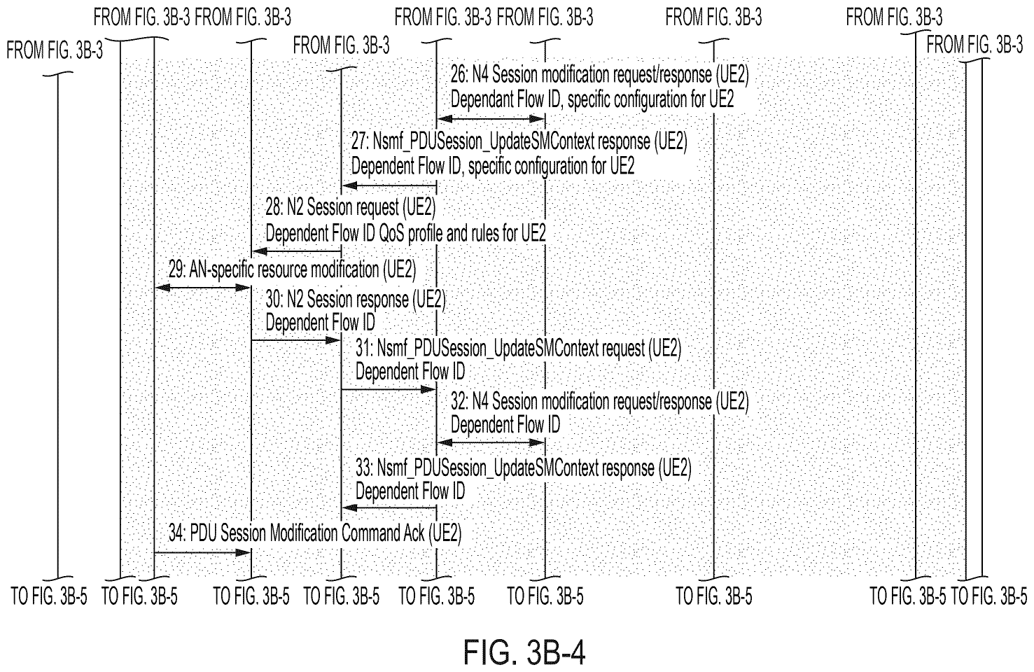

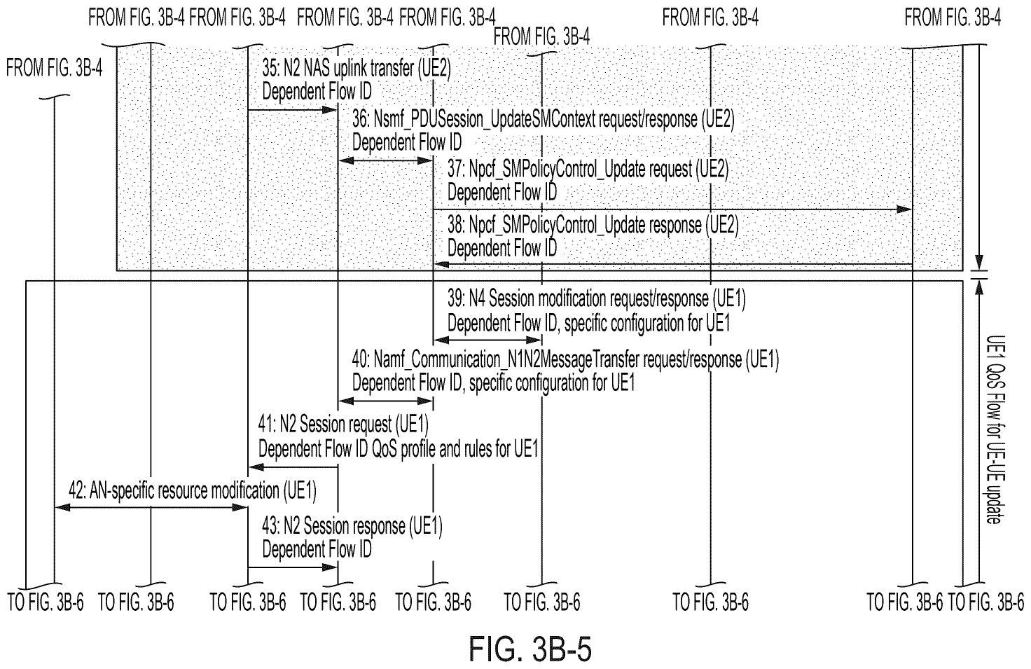

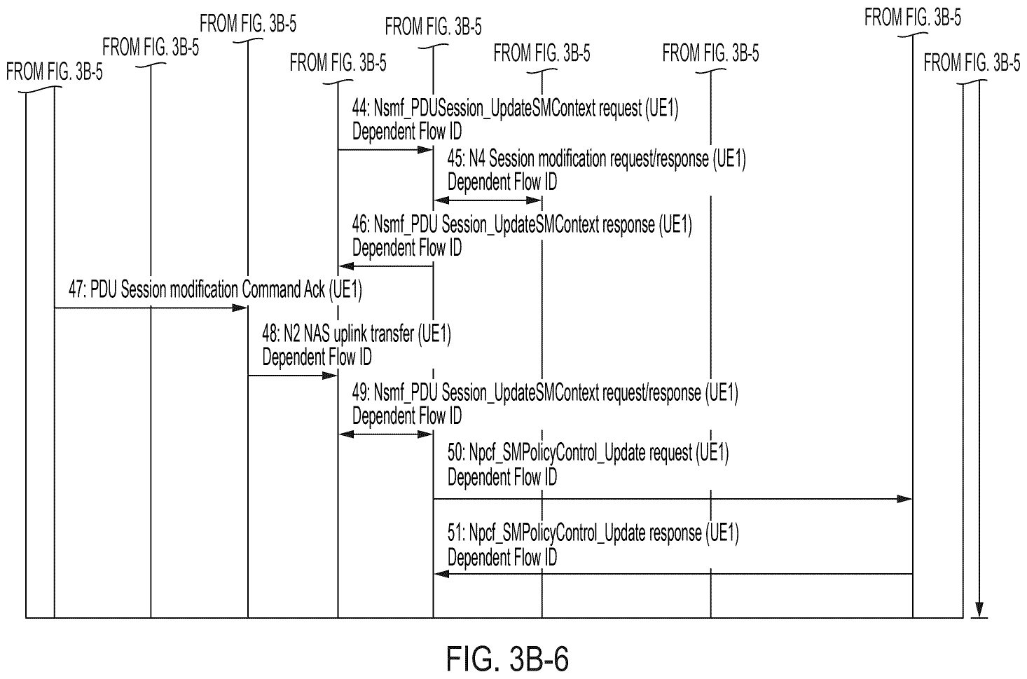

FIGS. 3A-1, 3A-2, and 3A-3 depict an example of a process flow for UE-UE communications, in accordance with some example embodiments. At the example of FIGS. 3A-1, 3A-2, and 3A-3, the UE-UE communication link establishment modification is triggered by the network (e.g., due to a request from an application function (AF) or other request from a node), although other nodes including a user equipment or application (e.g., an application at an application server or other device) may trigger a session modification for the UE-UE communications link. The description of FIGS. 3A-1, 3A-2, and 3A-3 also refers to FIGS. 1A-B.

In the example of FIGS. 3A-1, 3A-2, and 3A-3, the establishment of a QoS flow for the UE-UE communications link 120 may be based on a QoS flow establishment from 3GPP 23,502 but extended to consider the context of the two UEs 102A-B implicated in the UE-UE communications link 120. For an initial QoS flow configuration, the PCF 280 may provide policy information, such as PDU session related policy information, policy and charging control (PCC) rule information, and/or the like, for the UE-UE communications link 120. This PCF may consider the current subscriber information that it has about both UEs 102A-B (e.g., delay between 102A-B, subscription profiles, or expected UEs behavior parameters) to determine the policy (e.g., PDU session related policy or PCC rules) for this UE-UE communications link 120.

In some example embodiments, a network node, such as the SMF 276 and the like, may allocate the Dependent Flow ID. And, this network node, such as the SMF and the like, may derive specific QoS profiles for the two QoS flows to be established over the first leg 105 and the second leg 107. In some embodiments, the network node may dynamically assign other related parameters as well including QFI (QoS flow identifier) and 5QI (5G QoS identifier) as part of the configuration of each leg 105 and 107 of the data path for the UE-UE communications link 120.

Moreover, there may be two customized packet delay budgets for each leg 105 and 107. During the signaling procedure to establish a QoS flow(s), the specific QoS characteristics for each leg may be signaled to the required nodes or network functions (NFs), that is, use of dynamically assigned 5QIs. Alternatively, standardized 5QIs may also be used if the QoS requirements can be met (e.g., standardized 5QIs may avoid signaling the configuration to the required nodes (or NFs) as they are already known in the network). Additionally, the network and/or UE(s) may need a way to define (or, e.g., modify) a 5QI configuration within the non-access stratum PDU session procedures requests. This reconfiguration may be achieved by adding the corresponding IEs within the request. Alternatively, or additionally, the external application server may need to request to the network new QoS characteristics later converted to a dynamically assigned 5QIs at the PCF. This dynamically assigned 5QI definition may later be signaled to the UEs and used when the UEs request a PDU session modification to establish/modify QoS flows.

The QoS profile and rules for each UE-UE communication leg 105 and 107 may be forwarded and configured in the involved 5G NFs (e.g., UE 102A, UE 102B, gNB 270, AMF 272, SMF 276, UPF 282, UPF 280, AF 250, and/or app server 328).

In the example of FIGS. 3A-1, 3A-2, and 3A-3, the UEs 102A-B may already be registered with the cellular network, and may have an initial session, such as a PDU session, already established as shown at 325. If a node, such as application server 328 or other node for example, requests that the cellular network (e.g., 5G system or node therein) establish a UE-UE communications link 120 between UEs 102A-B, the cellular network may trigger a PDU session modification procedure in both UEs 102A-B to configure two, modified QoS flows.

At 301, a node, such as the application server 328, may provide one or more parameters to the AF 250 in order to request the establishment (e.g., creation, modification, release, etc.) of a UE-UE communication link 120 between two UEs 102A-B. This request may include information, such as QoS requirements (e.g., delay, periodicity, burst arrival time, packet size), a traffic description, identifiers for the UEs 102A-B (e.g., IP address, MAC address, or any other identifier for the UE), an AF transaction identifier, a UE IP address preservation indication, a temporal validity condition, information regarding an Application Function (AF) subscription to corresponding SMF events, and/or the like.

At 302, a node, such as the Application Function (AF) 250, may receive the request for establishment (which was noted at 301 and received by the AF 250), and may forward the request to another node, such as a policy control function (PCF) 280. This request may be targeted to two PDU sessions for each of the legs 105 and 107.

At 303, the PCF 280 may transform the request into one or more policies that can be applied to modify both PDU sessions, such as a modification to the PDU sessions associated with UE 102A and a modification to the PDU session associated with UE 102B. The policy may be the PDU session related policy information, PCC rules, and/or the like.

At 304, the PCF 280 may update the SMF 276 (or other node) with policy information about both PDU sessions associated with UE 102A and a modification to the PDU session associated with UE 102B. This update may be for example the PDU session related policy information, PCC rules, and/or the like. The update in this step is based on the policy derived in the previous step.

At 305, the SMF 276 may derive one or mode QoS parameters for the two QoS flows (one flow over leg 105 and another flow over leg 107) to be established within the UE-UE communication link 120. The SMF may allocate a Dependent Flow ID to link both of these QoS flows. In other words, the SMF may assign a Dependent Flow ID that maps to (e.g., identifies, links, etc.) to the QoS flows, so that a network node can detect that the two QoS flows (one flow over leg 105 and another flow over leg 107) are jointly part of the UE-UE communication link 120, for example. The SMF may be triggered to perform 305 based on the UE triggering the UE-UE communications (e.g., by the “Linked UE address” or a destination address in the QoS rule of the requested QoS Flow within the PDU session procedure). Alternatively, or additionally, the SMF may be triggered to perform 305 based on an AF requesting the UE-UE communications (e.g., the AF request reuse of a configuration of a 5G virtual network group or some other parameter). If the AF triggers UE-UE communications, the PCF may first detect the need of UE-UE communications and notifies the SMF.

At 306, the SMF 276 may send a message to acknowledge the PCF 280. This acknowledgment may include the Dependent Flow ID. The Dependent Flow ID may be considered an explicit indicator that links two policies at the PCF (e.g., linking two UEs 102A-B). The PCF may store the Dependent Flow ID. And later when the policy of one of the UEs is to be modified, if the Dependent Flow ID is stored, the PCF detects (e.g., determines, recognizes, etc.) that another UE is linked and should be considered in service decisions regarding the linked UEs 102A-B.

At 307, the SMF 376 may forward to the AMF 272 (which is associated with the UE 102A) a message including the allocated Dependent Flow ID and other information including the derived QoS profiles and/or rules to be used for the first UE 102A. In the case of the NAMF interface at the AMF, the message may have an N1 SM container including Dependent Flow ID, QoS rules, QoS Flow level QoS parameters, and/or corresponding QoS rules.

At 308, the SMF 376 may forward to the AMF 272 (which is associated with the UE 102B) a message including the allocated Dependent Flow ID and the derived QoS profiles and/or rules to be used for the first UE 102B. In the case of the NAMF interface at the AMF, the message may have an NI SM container including Dependent Flow ID, QoS rules, QoS Flow level QoS parameters, and corresponding QoS rules. The AMF may store the Dependent Flow ID in order to enable the AMF to behave differently when there is a trigger on a session that is linked to another session (e.g., when there is a release, or a modification due to handover associated with UEs 102A-B). The AMF may forward QoS profiles and/or rules.

At 309, the AMF 272 may send a session request message to the gNB 270 serving UE 102A, in accordance with some example embodiments. This message may include the Dependent flow ID and the QoS information for UE 102A. The gNB may store the Dependent Flow ID in order to enable the gNB to behave differently when the traffic changes as the uplink and/or downlink streams may be linked within the same gNB. For example, the Dependent Flow ID may impact the scheduler at the gNB, or how the gNB behaves when there are different events such as a mobility event, a radio resource release, a radio failure, and/or the like.

At 310, the radio access network (gNB 270) may modify the radio portion of the session such as the PDU session based on the Dependent flow ID and/or the QoS information for UE 102A. For example, UE modifying the necessary radio access network resources related to the PDU session (e.g., establish, modify, and/or release radio bearers).

At 311, the gNB 270 may send to the AMF 272 a session response including the Dependent flow ID as well as other information such as a tunnel identifier (which identifies the tunnel at the radio access network carry the modified session).

At 312, the AMF 272 may send to the SMF 276 a message including the Dependent flow ID. For example, the message may be a session update message including the Dependent flow ID and the tunnel identifier. At 313, the session modification request and response may occur, and these messages may include the Dependent flow ID as well as other information (e.g., packet detection rules (PDRs), forwarding action rules (FARs), usage reporting rules (URRs), and QoS enforcement rules (QERs)). At 314, the SMF 276 may send a message to the AMF 272. This message may include the Dependent flow ID. At 315, the UE 102A may send a message to gNB 270 to acknowledge to the network the session modification. For example, a PDU session modification command acknowledgement may be sent at 315 to acknowledge that the session has been modified based on the command received at 310.

At 317, there may be a session context exchange at the AMF 272 and SMF 276. This session context may include the Dependent flow ID as well as other information related to the UE 102A and/or 102B. For example, the AMF forwards the N1 SM container (PDU Session Modification Command Ack) and User Location Information received from the access network to the SMF.

At 328A, the QoS flow for the first leg 105 of link 120 for UE-UE communications link 120 is established as noted at 309-317. At 328B, the QoS flow for the second leg 107 of link 120 for UE-UE communications link 120 is established as shown at 318-326 (which may be the same or similar as described at 309-317).

The Dependent Flow ID allows different nodes, such as the UEs 102A-B, gNB 270, AMF 272, SMF 276, UPF 282, PCF 280, AF 250, and/or app server 328 to map the link 120 between both UEs 120A-B at different levels depending on their NF functionalities regarding user plane management. For example, the UPF may link two N4 sessions IDs, and the gNB may link two DRBs. This mapping may enable the tracking of the state of the UE-UE communication link 120.

In some example embodiments, the AMF may use the Dependent Flow ID to detect that if one of the legs (105, for example) is released, the other leg (107, for example) should also be released. As such, one release procedure in one UE may trigger another release procedure in the other UE. A similar release procedure may occur at the gNB.

In some example embodiments, the gNB(s) may use the Dependent Flow ID to improve scheduler management. For example, if the same gNB is serving both UEs 102A-B and the core network payload delay budget (PDB) is known, the gNB knows one UL traffic 105A from a specific DRB is going to be DL traffic 107A in a certain “x” milliseconds for that DL traffic.

In some example embodiments, the UPF may use the Dependent Flow ID to manage usage reporting or QoS enforcement as the UL traffic 105A for UE 102A's QoS Flow X is the same as DL traffic 107A for U 102B's QoS Flow Y. At the UPF, the PCFP session update/report for the first UE 102A may trigger, based on the Dependent Flow ID, an update/report for the second linked UE 102B.

In some example embodiments, the UE route selection policy (URSP) update for a first UE 102A may trigger, based on the Dependent Flow ID linking the two flows for UEs, an update for the second UE 102B's URSP.

In some example embodiments, the SMF may use the Dependent Flow ID when reconfiguring the access-level specific QoS parameters for the first UE 102A, which may thus trigger the reconfiguration for second linked UE 102B.

FIGS. 3B-1, 3B-2, 3B-3, 3B-4, 3B-5, and 3B-6 depict another example of a process flow for UE-UE communications, in accordance with some example embodiments. In the example of FIGS. 3B-1, 3B-2, 3B-3, 3B-4, 3B-5, and 3B-6, the UEs 102A-B may already be registered with the cellular network, and may have an initial session, such as a PDU session, already established as shown at 325. Moreover, the UEs 102-B may already have information about the UE-UE communication link. This information may include the destination address for each UE in the UE link that later is included in the Linked UE address (e.g., UEs can discover each other via application layer user-plane traffic or receive the information from the AF via the user-plane), or the information may include the 5QI.

At 1, the UE 102A may send a message to the AMF 272 to request a session modification. For example, the UE 102A may send a PDU session modification request that includes a Linked UE address, such as the IP address of UE 102B which is the target, destination for the UE-UE communications. In other words, the UE 102A requests a new QoS flow, and adds the Linked UE address as this QoS flow is going to be used to communicate with UE 102B as part of the UE-UE communications. The AMF may forward, at 2, the Linked UE address to the SMF 276.

At 3, the SMF 276 may extract the current context (for UE 102A) that may affect the establishment of the UE-UE communications link between UE 102A and UE 102B. The SMF checks the request and stores the information along with other information about UE 102A. The QoS flow may be established based on the UE 102A to UPF path (e.g., leg 105). This QoS flow configuration is a temporal QoS flow configuration (which may change during the later configuration of the UE-UE communications).

At 4-18, the signaling proceeds to establish a QoS flow for UE 102A for the UE-UE communications link 120 with UE 102B.

At 19, the UE 102B may send a message to an AMF, such as AMF 272, to request a session modification. For example, the UE 102B may send a PDU session modification request including a Linked UE address, such as the IP address of UE 102A which is the target, destination for its UE-UE communications. The AMF may forward, at 20, the Linked UE address identifying UE 102A to an SMF, such as the SMF 276.

At 21, the SMF may extract the current context it has on UE 102B that may affect the establishment of the UE-UE communications link between UE 102A and UE 102B. Given that both UEs have requested the UE-UE communications, the UE-UE communications may be established. In other words, the UE 102B requests, at 102B, a new QoS flow and adds a Linked UE address identifying UE 102A as this QoS flow is for UE-UE communications with UE 102A. The SMF may receive the request (and the Linked UE address information element), check the information, and the SMF may then correlate both QoS flow requests from UE 102A and UE 102B to identify the UE-UE communication needed between UE 102A and UE 102B. At 22, the SMF may forwards the information to the PCF.

At 23, the PCF may make a policy decision based on both UEs 102A-B that are establishing UE-UE communications. For example, the PCF may configure the policies considering both UEs 102A-B connectivity (e.g., over the whole path via UE 102A, UPF, and UE 102B). At 24, the PCF may send a message to the SMF 276, and this message may include an updated policy to enable the requested UE-UE communications.

At 25, the SMF 276 may derive one or more QoS parameters for the linked QoS flows over each leg 105 and 107. The SMF may, at 25, allocate a Dependent Flow ID to link the QoS flows used from UE 102A to UE 102B. At 26, the SMF and UPF 282 may exchange session modification request and response messages, which include the Dependent Flow ID and a configuration for UE 102B. At 27, the SMF 276 may send a message to the AMF 272, and this message may include the Dependent Flow ID and a configuration for UE 102B. At 28, the AMF may send to the gNB 270 a message including the Dependent Flow ID and QoS profile and/or rules for UE 102B. At 29, the gNB may make access network specific resources modifications for the UE 102B to provide the UE-UE communications in accordance with the received Dependent Flow ID, QoS profile and/or rules. At 30, the gNB 270 may send to the AMF 272 a session response message including the Dependent Flow ID linking UE 102A and 102B. At 31-38, the flow establishment messages may include the Dependent Flow ID as shown at FIGS. 3B-1, 3B-2, 3B-3, 3B-4, 3B-5, and 3B-6 to enable network nodes to know the linking of the UE 102A-B (or the QoS flows) which are in UE-UE communications.

At FIGS. 3B-1, 3B-2, 3B-3, 3B-4, 3B-5, and 3B-6, messages 39-51 correspond to the flow reconfiguration for UE 102A. These messages may include the Dependent Link ID as shown at FIGS. 3B-1, 3B-2, 3B-3, 3B-4, 3B-5, and 3B-6 as well. And, messages 39-51 may be implemented in the same or similar manner as messages 27-36 above.

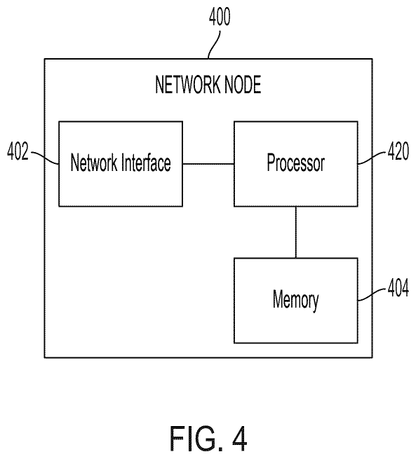

FIG. 4 depicts a block diagram of a network node 800, in accordance with some example embodiments. The network node 400 may be configured to provide one or more network side functions, such as a base station (e.g., base station (e.g., gNB, RAN, etc.), AMF 272, PCF 280, AF 250, CNC 204, CUC 202, and/or other network nodes.

The network node 400 may include a network interface 402, a processor 420, and a memory 804, in accordance with some example embodiments. The network interface 402 may include wired and/or wireless transceivers to enable access other nodes including base stations, devices 252-280, the Internet, and/or other nodes. The memory 404 may comprise volatile and/or non-volatile memory including program code, which when executed by at least one processor 420 provides, among other things, the processes disclosed herein with respect to the network node. In some example embodiment, the network node may receive and/or generate an indication indicative of two flows including a first flow and a second flow, the two flows carrying data from a first user equipment via a cellular network to a second user equipment. The indication may be generated based on a request from the first user equipment, the second user equipment, and/or an application function. The network node may be further caused to at least link, based at least on the indication, the first flow to the second flow to enable modification of the two flows. The first flow may include a first protocol data unit session of the first user equipment, and the second flow may include a second protocol data unit session of the second user equipment. The network node may be further caused to at least derive at least one of a quality of service parameter or a policy that considers both the first flow and the second flow, the derivation based on at least the connectivity conditions of both the first user equipment and the second user equipment. The indication may be received from a policy control function. The indication may be included in a policy control message. The network node may be further caused to at least send the indication towards another node so that the first flow and the second flow can be established, modified, released, and/or created based on at least the connectivity conditions of both the first user equipment and the second user equipment. The indication may include a dependent flow identifier indicating the first flow and the second flow are linked. The indication may include an address of the second user equipment. The first flow and the second flow may carry time sensitive communications between the first user equipment and the second user equipment via at least one network node.

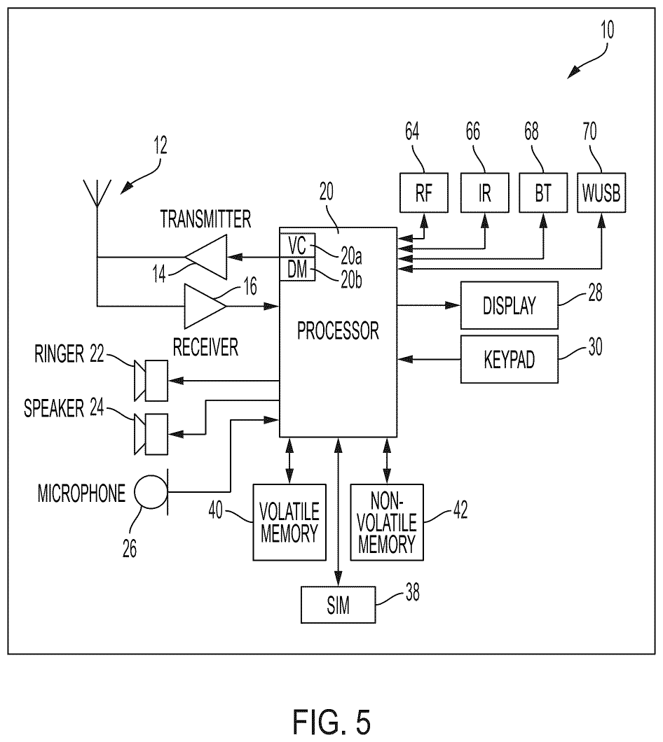

FIG. 5 illustrates a block diagram of an apparatus 10, in accordance with some example embodiments.

The apparatus 10 may represent a user equipment, such as the user equipment 102A-B. The user equipment may be coupled to, or included in, other devices to enable communications, such as TSN, TSC, and/or the like. In some example embodiments, the user equipment is associated with a machine, rather than a specific user.

The apparatus 10 may include at least one antenna 12 in communication with a transmitter 14 and a receiver 16. Alternatively transmit and receive antennas may be separate. The apparatus 10 may also include a processor 20 configured to provide signals to and receive signals from the transmitter and receiver, respectively, and to control the functioning of the apparatus. Processor 20 may be configured to control the functioning of the transmitter and receiver by effecting control signaling via electrical leads to the transmitter and receiver. Likewise, processor 20 may be configured to control other elements of apparatus 10 by effecting control signaling via electrical leads connecting processor 20 to the other elements, such as a display or a memory. The processor 20 may, for example, be embodied in a variety of ways including circuitry, at least one processing core, one or more microprocessors with accompanying digital signal processor(s), one or more processor(s) without an accompanying digital signal processor, one or more coprocessors, one or more multi-core processors, one or more controllers, processing circuitry, one or more computers, various other processing elements including integrated circuits (for example, an application specific integrated circuit (ASIC), a field programmable gate array (FPGA), and/or the like), or some combination thereof. Accordingly, although illustrated in FIG. 5 as a single processor, in some example embodiments the processor 20 may comprise a plurality of processors or processing cores.

The apparatus 10 may be capable of operating with one or more air interface standards, communication protocols, modulation types, access types, and/or the like. Signals sent and received by the processor 20 may include signaling information in accordance with an air interface standard of an applicable cellular system, and/or any number of different wireline or wireless networking techniques, comprising but not limited to Wi-Fi, wireless local access network (WLAN) techniques, such as Institute of Electrical and Electronics Engineers (IEEE) 802.11, 802.16, 802.3, ADSL, DOCSIS, and/or the like. In addition, these signals may include speech data, user generated data, user requested data, and/or the like.

For example, the apparatus 10 and/or a cellular modem therein may be capable of operating in accordance with various first generation (1G) communication protocols, second generation (2G or 2.5G) communication protocols, third-generation (3G) communication protocols, fourth-generation (4G) communication protocols, fifth-generation (5G) communication protocols, Internet Protocol Multimedia Subsystem (IMS) communication protocols (for example, session initiation protocol (SIP) and/or the like. For example, the apparatus 10 may be capable of operating in accordance with 2G wireless communication protocols IS-136, Time Division Multiple Access TDMA, Global System for Mobile communications, GSM, IS-95, Code Division Multiple Access, CDMA, and/or the like. In addition, for example, the apparatus 10 may be capable of operating in accordance with 2.5G wireless communication protocols General Packet Radio Service (GPRS), Enhanced Data GSM Environment (EDGE), and/or the like. Further, for example, the apparatus 10 may be capable of operating in accordance with 3G wireless communication protocols, such as Universal Mobile Telecommunications System (UMTS), Code Division Multiple Access 2000 (CDMA2000), Wideband Code Division Multiple Access (WCDMA), Time Division-Synchronous Code Division Multiple Access (TD-SCDMA), and/or the like. The apparatus 10 may be additionally capable of operating in accordance with 3.9G wireless communication protocols, such as Long Term Evolution (LTE), Evolved Universal Terrestrial Radio Access Network (E-UTRAN), and/or the like. Additionally, for example, the apparatus 10 may be capable of operating in accordance with 4G wireless communication protocols, such as LTE Advanced, 5G, and/or the like as well as similar wireless communication protocols that may be subsequently developed.

It is understood that the processor 20 may include circuitry for implementing audio/video and logic functions of apparatus 10. For example, the processor 20 may comprise a digital signal processor device, a microprocessor device, an analog-to-digital converter, a digital-to-analog converter, and/or the like. Control and signal processing functions of the apparatus 10 may be allocated between these devices according to their respective capabilities. The processor 20 may additionally comprise an internal voice coder (VC) 20a, an internal data modem (DM) 20b, and/or the like. Further, the processor 20 may include functionality to operate one or more software programs, which may be stored in memory. In general, processor 20 and stored software instructions may be configured to cause apparatus 10 to perform actions. For example, processor 20 may be capable of operating a connectivity program, such as a web browser. The connectivity program may allow the apparatus 10 to transmit and receive web content, such as location-based content, according to a protocol, such as wireless application protocol, WAP, hypertext transfer protocol, HTTP, and/or the like.

Apparatus 10 may also comprise a user interface including, for example, an earphone or speaker 24, a ringer 22, a microphone 26, a display 28, a user input interface, and/or the like, which may be operationally coupled to the processor 20. The display 28 may, as noted above, include a touch sensitive display, where a user may touch and/or gesture to make selections, enter values, and/or the like. The processor 20 may also include user interface circuitry configured to control at least some functions of one or more elements of the user interface, such as the speaker 24, the ringer 22, the microphone 26, the display 28, and/or the like. The processor 20 and/or user interface circuitry comprising the processor 20 may be configured to control one or more functions of one or more elements of the user interface through computer program instructions, for example, software and/or firmware, stored on a memory accessible to the processor 20, for example, volatile memory 40, non-volatile memory 42, and/or the like. The apparatus 10 may include a battery for powering various circuits related to the mobile terminal, for example, a circuit to provide mechanical vibration as a detectable output. The user input interface may comprise devices allowing the apparatus 20 to receive data, such as a keypad 30 (which can be a virtual keyboard presented on display 28 or an externally coupled keyboard) and/or other input devices.

As shown in FIG. 5, apparatus 10 may also include one or more mechanisms for sharing and/or obtaining data. For example, the apparatus 10 may include a short-range radio frequency (RF) transceiver and/or interrogator 64, so data may be shared with and/or obtained from electronic devices in accordance with RF techniques. The apparatus 10 may include other short-range transceivers, such as an infrared (IR) transceiver 66, a Bluetooth™ (BT) transceiver 68 operating using Bluetooth™ wireless technology, a wireless universal serial bus (USB) transceiver 70, a Bluetooth™ Low Energy transceiver, a ZigBee transceiver, an ANT transceiver, a cellular device-to-device transceiver, a wireless local area link transceiver, and/or any other short-range radio technology. Apparatus 10 and, in particular, the short-range transceiver may be capable of transmitting data to and/or receiving data from electronic devices within the proximity of the apparatus, such as within 10 meters, for example. The apparatus 10 including the Wi-Fi or wireless local area networking modem may also be capable of transmitting and/or receiving data from electronic devices according to various wireless networking techniques, including 6LoWpan, Wi-Fi, Wi-Fi low power, WLAN techniques such as IEEE 802.11 techniques, IEEE 802.15 techniques, IEEE 802.16 techniques, and/or the like.

The apparatus 10 may comprise memory, such as a subscriber identity module (SIM) 38, a removable user identity module (R-UIM), an eUICC, an UICC, and/or the like, which may store information elements related to a mobile subscriber. In addition to the SIM, the apparatus 10 may include other removable and/or fixed memory. The apparatus 10 may include volatile memory 40 and/or non-volatile memory 42. For example, volatile memory 40 may include Random Access Memory (RAM) including dynamic and/or static RAM, on-chip or off-chip cache memory, and/or the like. Non-volatile memory 42, which may be embedded and/or removable, may include, for example, read-only memory, flash memory, magnetic storage devices, for example, hard disks, floppy disk drives, magnetic tape, optical disc drives and/or media, non-volatile random access memory (NVRAM), and/or the like. Like volatile memory 40, non-volatile memory 42 may include a cache area for temporary storage of data. At least part of the volatile and/or non-volatile memory may be embedded in processor 20. The memories may store one or more software programs, instructions, pieces of information, data, and/or the like which may be used by the apparatus for performing operations disclosed herein. Alternatively or additionally, the apparatus may be configured to cause the operations disclosed herein with respect to the base stations/WLAN access points and network nodes including the UEs.

The memories may comprise an identifier, such as an international mobile equipment identification (IMEI) code, capable of uniquely identifying apparatus 10. The memories may comprise an identifier, such as an international mobile equipment identification (IMEI) code, capable of uniquely identifying apparatus 10. In some example embodiments, the processor 20 may be configured using computer code stored at memory 40 and/or 42 to the provide operations disclosed herein with respect to the UE. In some example embodiment, the apparatus, such as a user equipment, may receive and/or generate an indication indicative of two flows including a first flow and a second flow, the two flows carrying data from a first user equipment via a cellular network to a second user equipment. The indication may be generated based on a request from the first user equipment, the second user equipment, and/or an application function. The apparatus may be further caused to at least link, based at least on the indication, the first flow to the second flow to enable modification of the two flows. The first flow may include a first protocol data unit session of the first user equipment, and the second flow may include a second protocol data unit session of the second user equipment. The apparatus may be further caused to at least derive at least one of a quality of service parameter a policy that considers both the first flow and the second flow, the derivation based on at least the connectivity conditions of both the first user equipment and the second user equipment. The indication may be received from a policy control function. The indication may be included in a policy control message. The apparatus may be further caused to at least send the indication towards another node so that the first flow and the second flow can be established, modified, released, and/or created based on at least the connectivity conditions of both the first user equipment and the second user equipment. The indication may include a dependent flow identifier indicating the first flow and the second flow are linked. The indication may include an address of the second user equipment. The first flow and the second flow may carry time sensitive communications between the first user equipment and the second user equipment via at least one network node.

Some of the embodiments disclosed herein may be implemented in software, hardware, application logic, or a combination of software, hardware, and application logic. The software, application logic, and/or hardware may reside on memory 40, the control apparatus 20, or electronic components, for example. In some example embodiment, the application logic, software or an instruction set is maintained on any one of various conventional computer-readable media. In the context of this document, a “computer-readable medium” may be any non-transitory media that can contain, store, communicate, propagate or transport the instructions for use by or in connection with an instruction execution system, apparatus, or device, such as a computer or data processor circuitry, with examples depicted at FIG. 5, computer-readable medium may comprise a non-transitory computer-readable storage medium that may be any media that can contain or store the instructions for use by or in connection with an instruction execution system, apparatus, or device, such as a computer.

Without in any way limiting the scope, interpretation, or application of the claims appearing below, a technical effect of one or more of the example embodiments disclosed herein may be better resource utilization of UE-UE communications links.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

If desired, the different functions discussed herein may be performed in a different order and/or concurrently with each other. Furthermore, if desired, one or more of the above-described functions may be optional or may be combined. Although various aspects of some of the embodiments are set out in the independent claims, other aspects of some of the embodiments comprise other combinations of features from the described embodiments and/or the dependent claims with the features of the independent claims, and not solely the combinations explicitly set out in the claims. It is also noted herein that while the above describes example embodiments, these descriptions should not be viewed in a limiting sense. Rather, there are several variations and modifications that may be made without departing from the scope of some of the embodiments as defined in the appended claims. Other embodiments may be within the scope of the following claims. The term “based on” includes “based on at least.” The use of the phase “such as” means “such as for example” unless otherwise indicated.

What is claimed:

1. An apparatus comprising:
at least one processor; and
at least one memory including computer program code, the at least one memory and the computer program code configured to, with the at least one processor, cause the apparatus to at least:
receive or generate an indication indicative of two flows including a first flow and a second flow, the two flows carrying data from a first user equipment via a cellular network to a second user equipment.
